(19) United States
(12) Patent Application Publication
(10) Pub. No.: US 2019/0275555 A1
(43) Pub. Date: Sep. 12, 2019

(54) SYSTEM AND METHOD FOR COATING DISCRETE PATCHES ON A MOVING SUBSTRATE

(71) Applicant: Faustel, Inc., Germantown, WI (US)

(72) Inventors: John J. Hartley, Jr., Pewaukee, WI (US); Samuel E. Gely, Jr., Menomonee Falls, WI (US)

(21) Appl. No.: 16/349,105

(22) PCT Filed: Nov. 10, 2016
(86) PCT No.: PCT/US2016/061266

§ 371 Date: May 10, 2019

(51) Int. Cl. B05C 5/02; B05C 11/10; B05D 1/26; H01M 4/04

(52) U.S. Cl. CPC B05C 5/0254; H01M 4/0402; B05D 1/26; B05C 11/1021

(57) ABSTRACT

An apparatus for accurately coating discrete patches of coating on a moving substrate is described. The coating system applies coating to a moving substrate using a coating distribution device. A flow pump pumps the coating from a reservoir into the coating distributing device where a portion of the coating is deposited and the remainder is allowed to returned back to the reservoir. The coating distribution device selectively meters a portion of the coating it receives from the flow pump onto the substrate at a variable rate. When the coating distribution device transitions from metering to not metering and to reverse metering, it induces a vacuum in the coating distribution device. The induced vacuum causes a portion of the coating being distributed onto the substrate to flow in reverse quickly breaking the deposition of the coating.

### BACKGROUND OF THE INVENTION

The present invention relates generally to the field of patch coating a substrate and, more specifically, to a coating system and distribution device for intermittently applying an even thickness coating to a substrate or web.

Certain commercial products require a manufacturing process that applies a substantially even layer of a viscous coating intermittently applied onto a substrate. This process is known as patch coating. In some cases the coated segments are separately cut out and formed into the finished product as is typical for medical patch application. The coated plastic is cut out and placed in a package where it can be used to apply medication to a patient. In other cases the patch coated substrate is laminated with other substrates and rolled in a flat oblong manner to form a prismatic battery cell. In a similar manner, the patch coated substrate may be used in the production of the flat pouch format battery cell. Both the prismatic and pouch format cells are common formats for the popular lithium-ion batteries. The pouch format makes the most efficient use of space and can achieve 95% packaging efficiency.

In the case of flat pouch or prismatic format lithium-ion batteries, a slurry solution is mixed and applied to a thin foil of aluminum, copper, or similar metal substrate. The composition of the slurry solution is dependent on the type of electrode being produced (i.e. anode or cathode). In typical lithium ion batteries, the slurry for the negative anode electrode is composed primarily of graphite or similar carbon based substance and some additional binding materials. The slurry for the positive cathode electrode varies depending on the type of battery being produced. Some examples for the primary agent in the cathode side slurry include Lithium Cobalt Oxide (LiCoO2), Lithium Manganese Oxide (LiMn2O4), Lithium Nickel Manganese Cobalt Oxide (LiNiMnCoO2 or NMC), Lithium Iron Phosphate (LiFePO4), Lithium Nickel Cobalt Aluminum Oxide (LiNiCoAlO2), and Lithium Titanate (Li4Ti5O12). Each compound has certain distinct characteristics that are useful in different batter applications.

The cathode and anode slurries are separately pumped onto long rolls of the metal substrate to produce intermittent patches of the material that can be cut out to form individual electrodes. When producing electrodes for flat packed lithium-ion batteries (pouch format), an even coating thickness is preferred. An even coating thickness allows for a uniform package when the final electrodes are stacked together. An un-even coating thickness produces a bowed final package which complicates the product design and causes reduced battery performance and reliability.

Current production systems employ a pump in conjunction with one or more bypass valves and one or more vacuum valves. The pump pumps the slurry through an applicator die onto the metal substrate when activated. The bypass valve is opened to divert coating back to the tank. This stops the application of the slurry and forms the intermittent patch coating. However stopping the pump alone is not sufficient to quickly stop the flow of the coating, because the bypass valves are too slow and operation too inconsistent to give a clean precise break in the coating transfer. This results in inconsistent and uneven coating being applied at the ends of the strips. This is also true when the bypass valve closes to begin the next patch strip. To help minimize this effect, a vacuumed valve can be employed. The vacuum valve is switched in line with the applicator die once the bypass valve is activated, which quickly pulls the slurry back from the lip of the applicator die and ceases application quicker than what the bypass valve can alone do. Unfortunately, this system has three disadvantages. First, it is cumbersome to employ by involving several different systems and having to have a separate system to supply the vacuum. Second, the vacuum does nothing to alleviate the coating thickness variation problem when the valve is turned back on. Third, the bypass valves and vacuum valves are simple on/off controls that do not have the ability to control the closing flow rate and open ramp speeds or the ability to profile the supply rate which is needed to precisely control the coating thickness on the lead and trailing edges of the patch. What is needed then is an integrated system that provides greater flow control of the coating during the transition period between the patches so even thicknesses patch is produced when both starting and stopping application of the coating.

### SUMMARY OF THE INVENTION

The invention provides, in one aspect, a coating system that includes a reservoir containing a coating, a first pump in fluid communication with the reservoir and configured to pump coating from the reservoir through one or more distribution lines, and a coating distribution device in fluid communication with and disposed downstream of the flow pump to receive coating. The coating distribution device includes a motor and a second pump coupled to and driven by the motor to selectively apply the coating to a substrate in the form of a patch. The second pump is configured to control flow of the coating through the coating distribution device at first flow rates to deposit the coating onto the substrate via an outlet, and is further configured to stop the flow of the coating through the coating distribution device to stop deposition of the coating on the substrate.

The invention provides, in another aspect, a web coating system that includes a transport roll supporting a substrate movable in a first direction at a first speed, a reservoir containing a coating, a first pump in fluid communication with the reservoir to pump fluid from the reservoir, and a coating distribution device. The coating distribution device is disposed downstream of the first pump and includes an inlet in fluid communication with the first pump. The coating distribution device also includes a motor and a second pump configured to deposit at least a portion of the coating from the first pump onto the substrate via an outlet. A controller is in operative communication with the transport roll and the motor, and is programmed to determine a speed of the transport roll and to generate a control signal to control the predetermined flow rate(s) of the second pump. The control signal is based on a predetermined size and thickness of an area of coating to be applied to the substrate. The second pump is controlled by the controller at different flow rate to generate the predetermined size and thickness of the coating area on the substrate.

The invention provides, in yet another aspect, a method of applying a coating to a substrate. The method includes pumping the coating from a reservoir to a coating distribution device using a first pump. The method also includes applying the coating to the substrate using the coating distribution device that includes a motor and a second pump driven by the motor. The method also includes controlling the flow of the coating generated by the second pump through the coating distribution device via a controller at first flow rates to deposit the coating onto the substrate via an outlet. The method also includes controlling the flow of the coating generated by the second pump through the coating distribution device via the controller at a second flow rate to stop deposition of the coating on the substrate.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a schematic view of an example embodiment of the coating system according to the present invention.

FIG. 2 is a schematic view of the integration of the microprocessor controller.

FIG. 3 is a side view of a substrate having 2 discrete coating patches.

FIG. 4 is a graph illustrating an exemplary flow rate of the coating system over time for the coating system as might be used to produce the 2 discrete coating patches in FIG. 3.

FIG. 5 is a flow chart of a program for the coating system.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

In addition, it should be understood that embodiments of the invention may include hardware, software, and electronic components or modules that, for purposes of discussion, may be illustrated and described as if the majority of the components were implemented solely in hardware. However, based on a reading of the detailed description, it should be recognized that, in at least one embodiment, electronic-based aspects of the invention may be implemented in software (e.g., instructions stored on non-transitory computer-readable medium) executable by one or more processing units, such as a microprocessor and/or application specific integrated circuits (“ASICs”). As such, it should be noted that a plurality of hardware and software based devices, as well as a plurality of different structural components may be utilized to implement the invention. For example, “servers” and “computing devices” described in the specification can include one or more processing units, one or more computer-readable medium modules, one or more input/output interfaces, and various connections (e.g., a system bus) connecting the components.

Referring generally to the figures, various embodiments of a coating system and coating distribution device are shown. The various embodiments of the coating system and distribution device provide for the dynamically controllable intermittent application of a coating to a substrate. Specifically, the system and device are controllable to produce a substantially even layer of coating by quickly beginning application of the coating from a stopped or off state and quickly stopping application of the coating from a running or on state.

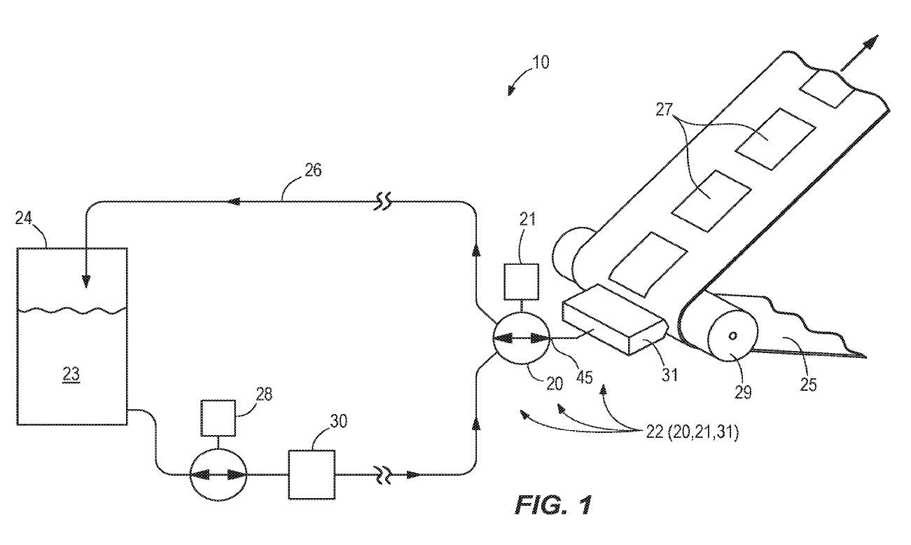

Referring to FIG. 1, an exemplary embodiment of a coating system or web coating system 10 is shown. The coating system 10 includes a coating distribution device 22, a container (e.g. tank, reservoir, etc.) 24, distribution lines (e.g. conduits, pipes, channels, passages, etc.) 26, a flow pump 28, a filter 30, web transport rolls 29, a web 25 (e.g., a sheet or substrate), and a coating 23. The coating distribution device 22 is fluidly coupled with the container 24 that holds coating 23, the flow pump 28, and the filter 30 via distribution lines 26. The coating distribution device 22 is configured to receive coating 23 from distribution lines 26, pass all or a portion of coating 23 received back into distribution lines 26 (e.g., a return distribution line) to be returned to container 24 forming a return conduit, and activate to distribute (e.g. excrete, expel, eject, emit, output, etc.) a portion of the received coating 23. In one embodiment, the coating distribution device 22 comprises a positive displacement pump 20 that is coupled to a stepper or servo motor 21 and a coating applicator die 31 having an outlet communicating the coating 23 to the substrate 25.

Distribution lines 26 can be manufactured from plastic or similar materials to produce flexible tubing for transporting coating 23 between the components of coating system 10. In one embodiment, flow pump 28 is a standard one direction pump configured to pump coating 23 at a constant rate. In another embodiment, the flow pump 28 can include a variable speed pump that varies the flow rate with the speed of the substrate 25. Filter 30 removes contaminants from coating 23 that may have been introduced to coating 23. In one embodiment, filter 30 can be omitted and the flow pump 28 can be fluidly coupled directly to the coating distribution device 22 through distribution lines 26. Rolls 29 transports substrate 25 in relation to coating distribution device 22.

Substrate 25 is a coatable material that is movable relative to coating distribution device 22. Various embodiments of substrate 25 including as a web or sheet are contemplated. In one embodiment, substrate 25 is a thin metallic (e.g. aluminum, copper, etc.) web configured for use as an electrode in a lithium-ion battery. In another embodiment, substrate 25 is a plastic sheet configured to absorb and distribute a pharmaceutical medication. Coating 23 is a liquid material with unique desirable properties suitable for the desired product. In yet another embodiment, coating 23 is a slurry solution for the anode of a lithium-ion battery. The active compound in a slurry solution for lithium-ion anodes is typically carbon based materials (e.g. graphite, graphene, etc.). In another embodiment, the coating 23 is a slurry solution for the cathode of a lithium-ion battery. The active compound in a slurry solution for lithium-ion cathodes depending on the type of battery being produced. Some examples for the primary agent in the cathode slurry include Lithium Cobalt Oxide (LiCoO2), Lithium Manganese Oxide (LiMn2O4), Lithium Nickel Manganese Cobalt Oxide (LiNiMnCoO2 or NMC), Lithium Iron Phosphate (LiFePO4), Lithium Nickel Cobalt Aluminum Oxide (LiNiCoAlO2), and Lithium Titanate (Li4Ti5O12). Each compound has certain distinct characteristics that are useful in different battery applications. In a further embodiment, coating 23 is a medical pharmaceutical.

In operation, coating 23 is prepared and loaded into the container 24. The flow pump 28 is activated to pump coating 23 from the container 24 through distribution lines 26, filter 30, and to the coating distribution device 22, and then back into the container 24 at a first flow rate. The flow pump 28 causes coating 23 to flow through the system in the direction indicated by arrows on distribution lines 26. The coating distribution device 22 is then activated along with the transport rolls 29. When activated, the coating distribution device 22 siphons off a portion of the coating 23 from the distribution line 26 and deposits that portion of coating 23 on to the substrate 25 at a second flow rate that is slower than the first flow rate when the system 10 actively pumps coating through the lines 26 and through the device 22. Having the second flow rate less than the first flow rate ensures that the inlet of the pump 20 in the device 22 is positively pressurized under all conditions and the index action of the pump in the device 22 does not need to accelerate and decelerate a large mass of coating in the distribution lines 26 all the way back to the container 24. In some embodiments, at least a portion of the coating 23 is continually returned to the container 24 through the distribution lines 26 when the pump 28 is active.

The roll 29 transports the substrate 25 past the coating distributing system 10 and the coating 23 is deposited onto the substrate 25 by the device 22 and the coating applicator die 31 so that the coating 23 forms a length of coating on the substrate 25 (e.g., forming a patch coat or patch 27) (FIG. 3). In one embodiment, the second flow rate is variable and is faster when the coating distribution device 22 is first activated, and then the second flow rate is reduced to a steady state. Having a faster initial flow rate allows the coating distribution device 22 to quickly begin depositing coating 23 onto substrate 25 to compensate for start conditions and to provide a substantially more even thickness of coating at the very initial edge of the coating patch 27.

After a period of time, coating distribution device 22 is paused and the second flow rate goes to zero to stop the depositing of coating 23 onto substrate 25. In one embodiment, in place of being deactivated, coating distribution device 22 induces the second flow rate to briefly be negative (negative indicating flow in a direction (e.g., to the left in FIG. 1) opposite the direction (e.g., to the right in FIG. 1) for depositing the coating 23 onto the substrate 25). Inducing a temporary negative flow rate generates a vacuum and increases the rate at which coating 23 separates from substrate 25 (i.e. terminating the coating patch), and causes coating 23 to flow back through coating applicator die 31 a short distance. This rapid reversal of flow stops distribution of coating 23 onto substrate 25 faster than when the second flow rate goes only to zero, and produces a cleaner trailing edge on the patch 27.

In one embodiment, the coating distribution device 22 includes the positive displacement pump 20, the servo or stepper motor 21 (referred to interchangeably in the description as the “servo motor 21 or the “stepper motor 21”), and the coating applicator die 31. The stepper motor 21 is capable of rapid index moves and can include a high response servo or stepper motor that is capable of starting, stopping, and reversing the pump 20. The positive displacement pump 20 can include a positive displacement gear pump that is modified to include one or more feed ports to allow for continuous coating recirculation through distribution lines 26 when the pump 20 is stopped. The pump 20 includes an output port 45 that connects to applicator die 31. Optimized selection and/or design of these components allows a system response time (the time by which the system starts, stops, or reverses) in as little as 2 ms. Positioning the pump 20 in close proximity to the applicator die 31 enhances the high speed operation of the coating distribution device 22. Applicator die 31 is a standard commercially available coating die comprised of 3 pieces, upper and lower halves and a shim that is can be modified to adjust for different coating patch width. As such, the applicator die 31 will not be described in detail.

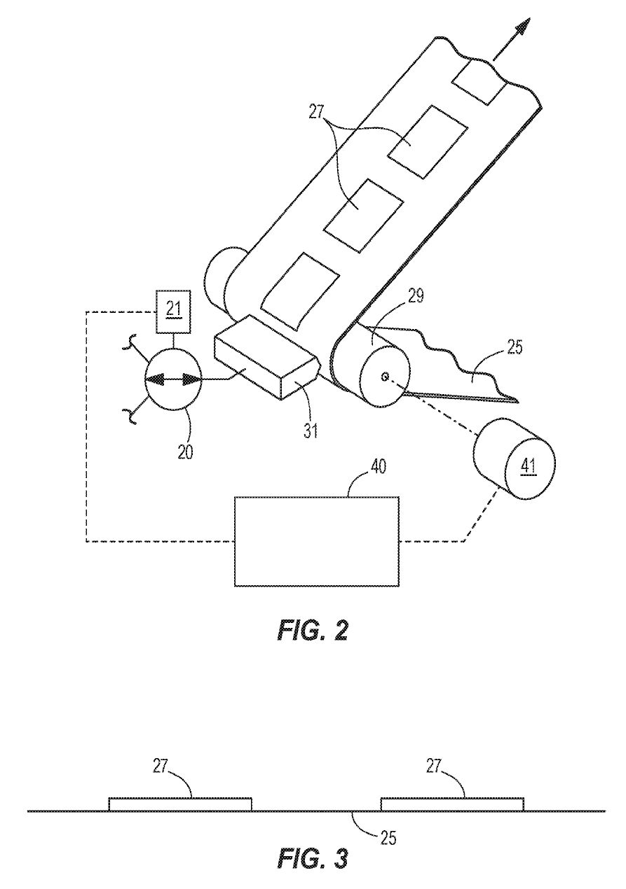

As shown in FIG. 2, the system 10 includes a controller 40 and a tachometer input device 41 (referred to as the “tachometer 41” for purposes of description). The controller 40 (e.g., a microcontroller, etc.) that has a memory configured to store software-based instructions (e.g., control protocols, operational data, etc.) and a processor configured to execute the software to carry out the functionality of the system 10 described herein. The controller 40 is coupled to coating distribution device 22 and transport rolls 29 by one or more communication links including, but not limited to, one or more wired or wireless connections, networks, and protocols including, but not limited to, a local area network (LAN), the Internet, Wi-Fi, cellular, LTE, 3G, Bluetooth, Ethernet, USB, and the like. In one embodiment, the controller 40 generates first and second control signals. The first control signal is indicative of one or both of the speed and direction of the transport roll 29. The second control signal controls the second flow rate of the coating distribution device 22. In this embodiment, the area of coating 23 applied to substrate 25 has a predetermined size and thickness. The controller 40 sets the first and second control signals such that the size and thickness of coating 23 applied to substrate 25 match the predetermined size and thickness. In another embodiment, the controller 40 is also coupled to the pump 28 to control the operation (e.g., the speed or flow rate) of the pump 28. In such an embodiment, the controller 40 generates a third control signal to operate the pump to maintain a flow of substrate to the pump that is greater than the flow rate of the pump 20.

In one embodiment, the controller 40 is coupled to the servo motor 21 and is configured to control the speed and direction of the servo motor 21 to control operation of the pump 20. The controller 40 also is coupled to the tachometer 41 by a communication link including, but not limited to, one or more wired or wireless connections, networks, and protocols including, but not limited to, a local area network (LAN), the Internet, Wi-Fi, cellular, LTE, 3G, Bluetooth, Ethernet, USB, and the like. The tachometer 41 is coupled directly or indirectly to the transport roll 29 to measure a process speed input of the transport roll 29 that is proportional to the speed of the substrate 25, and provide the process speed input to the controller 40. Based on the process speed input, the controller 40 determines, via the processor, an output signal to control the speed and direction of the servo motor 21. The output signal sets a coating thickness by setting the speed of the pump 20 relative to process speed input signal from the tachometer 41. In addition, the output signal sets a length of the patch and a distance between patches by the timed stopping and starting of the gear pump 20 relative to the process speed input from tachometer 41. Depending on the desired coating length or thickness, the controller 40 is programmed to generate an output signal to servo motor 21 that controls the pump 20 to produce the desired thickness and length of the coating patch. After the flow pump 28 is initiated and the coating flows through the system 10 at the first flow rate, the application of coating 23 onto the substrate 25 begins when the signal from controller 40 commands the operation of the servo motor 21 to drive the pump 20 according to a predetermined program consistent with what is described herein.

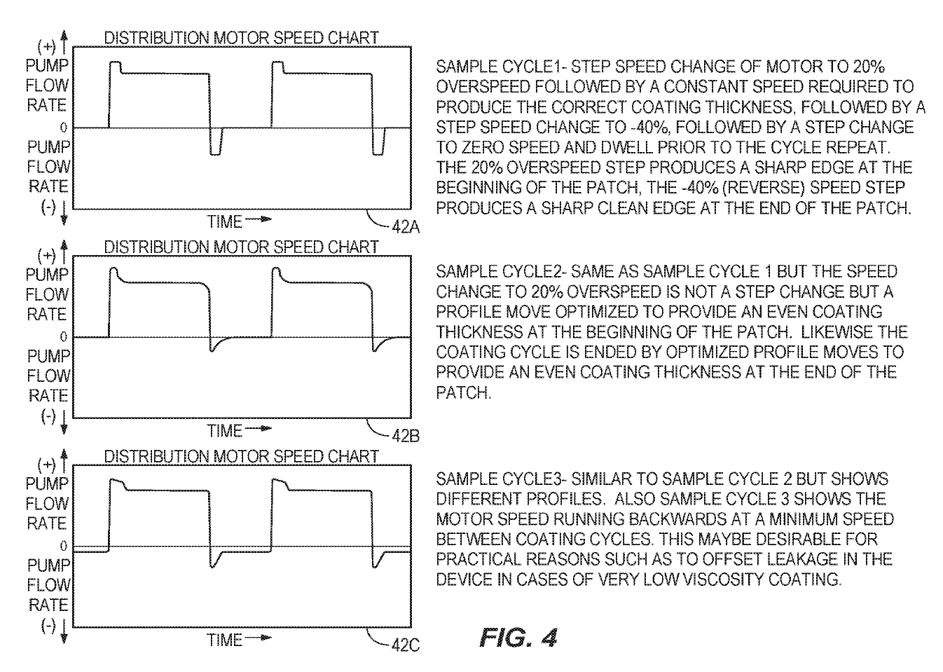

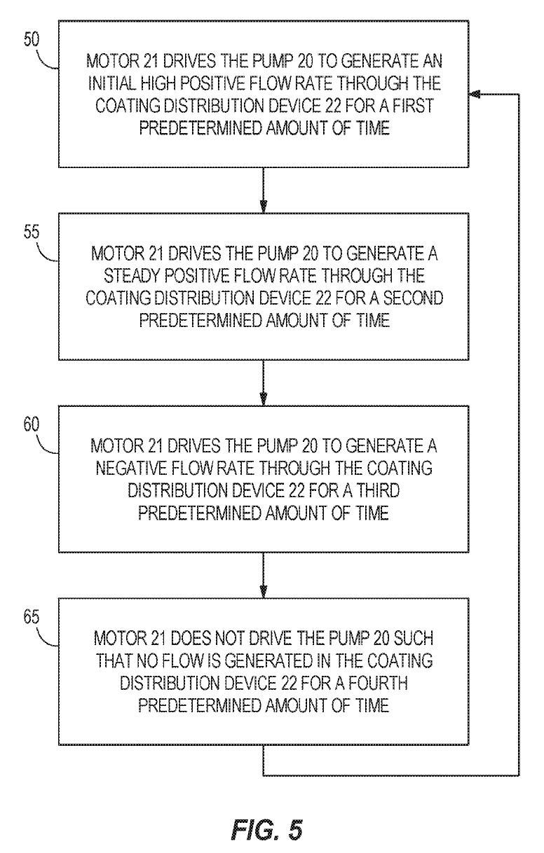

Exemplary programs to coat discrete patches onto a moving substrate using the system described above is best understood with regard to the charts 42A, 42B, 42C shown in FIG. 4 and flow chart shown in FIG. 5. In a first step 50, the controller 40 operates the servo motor 21 to drive the pump 20 to generate an initial high positive flow rate through the coating distribution device 22 for a first predetermined amount of time. In a second step 55, the controller 40 operates the servo motor 21 to drive the pump 20 to generate a steady positive flow rate through the coating distribution device 22 that is less than the initial high positive flow rate for a second predetermined amount of time (e.g., an amount of time that is greater than the first predetermined amount of time, or a lesser amount of time). In a third step 60, the controller 40 reverses operation of the servo motor 21 to drive the pump 20 to generate a negative flow rate through coating distribution device 22 (i.e., coating is drawn into the applicator die 31) for a third predetermined amount of time. The third step 60 terminates coating such that a discrete patch is formed on the substrate 25, while also pulling a bead of coating on the die 31 back into the die 31 to produce a clean break of the deposition of the coating. In a fourth step 65, the controller 40 does not operate the servo motor 21 for a fourth predetermined amount of time such that the pump is not driven and no flow is generated in the coating distribution device 22. This pause in operation forms a gap between the patches.

The chart 42A illustrates implementation of an exemplary program to coat discrete patches. With reference to chart 42, an exemplary speed of the motor 21 at the first step 50 is approximately 20% overspeed (step speed change), which is followed by the second step 55 operating the motor at a constant or substantially constant speed to produce the desired coating thickness. At the third step 60, the speed of the motor 21 is adjusted to a speed change of −40%, which is followed by a step change to zero speed for a period of time. The 20% overspeed in the first step 50 produces a clean or sharp edge on the front end of the patch 27, and the −40% reverse speed at the third step 60 produces a clean or sharp edge at the end of the patch 27.

The chart 42B in FIG. 4 illustrates implementation of another exemplary program to coat patches that is similar to what is shown in chart 42A. The primary differences include the 20% overspeed (first step 50) having a curved profile rather than a stepped profile and a curved profile at the fourth step 65. The curved profiles are optimized to produce an even coating thickness at the beginning and end of the patch 27.

The chart 42C illustrates implementation of yet another exemplary program. The first step 50 can have a stepped or curved profile overspeed (e.g., 20%). Similarly, the fourth step 65 can have a stepped or curved profile positive speed for the motor 21. Unlike the charts 42A, 42B, the fourth step 65 illustrated in chart 42C also includes operating the motor 21, via the controller 40, during the fourth predetermined amount of time such that the pump 20 is driven at a low negative flow rate to, for example, offset, limit, or prevent leakage in the pump 20. After the fourth step 65, the program is repeated until the desired quantity of patches is formed on the substrate. In other words, operating the system according to the chart 42C does not return the pump speed to zero during coating.

In the program described above, the flow rates and the predetermined amounts of time associated with each step may be varied to, for example, alter the size and the thickness of the patches of coating formed on the substrate. In addition, the flow rates and predetermined amounts of time associated with each step may vary within a program to generate patches of coating having different sizes and/or thicknesses on the substrate.

Provided below is a table including exemplary characteristics of a patch coating and profile program implemented in a manner that is consistent with what has been described above:

Sample Patch Dimensions

| | |
|---|---|
| Patch Width | 8 inches |
| Patch Length | 12 inches |
| Coating Thickness | .005 inches |
| Gap between Patches | 6 inches |
| Transport Speed | 50 feet/min. |
| Distribution Pump (20) capacity | .075 cubic inches/revolution |

Calculated Values

| | |
|---|---|
| Length of Patch in seconds | 1.20 seconds @ 50 ft/min |
| Length of Gap in seconds | .60 seconds @ 50 ft/min |
| Speed of pump | 400 rpm (to produce .005″ thick × |
| | 8″ W patch @ 50 fpm) |

Sample Cycle (e.g., Sample Cycle 1 in FIG. 4)

| | |
|---|---|
| 1. | Pump speed accelerates from 0 to 480 rpm in .002 seconds (High |
| | response stepper motor move) |
| 2. | Pump speed stays at 480 rpm for .100 seconds (Establishes clean |
| | starting edge of patch) |
| 3. | Pump speed decelerates from 480 to 400 rpm in .001 seconds (High |
| | response stepper motor move) |
| 4. | Pump stays at 400 rpm for 1.1 seconds (400 rpm @ 50 fpm steady |
| | state gives .005″ coating thickness) |
| 5. | Pump speed decelerates from 400 rpm to −160 rpm in .002 seconds |
| | (High response stepper motor move) |
| 6. | Pump stays at −160 rpm for .100 seconds (Pulls coating back into |
| | distribution die to give clean edge) |
| 7. | Pump speed goes from −160 rpm to 0 rpm. (response time |
| | is not critical) |
| 8. | Pump speed stays at 0 rpm for .500 seconds (This is the uncoated gap |
| | area between the patches) |
| 9. | Cycle complete. Cycle repeats. |

The system and program described above embodies numerous advantages over prior art systems. It should be clear that the controlled use of the servo motor 21 and the gear pump 20 allows for control of the application of a coating on a substrate not seen in prior art devices that use a valve. For example, the flow rate in the system 10 can be increased and decreased while the pump 28 is operated continuously such that dynamic control of the application of coating is achieved. This dynamic control can account for the irregularities and non-uniformities caused at the leading and trailing edge of a patch caused by flow conditions during the beginning and ends of coating application. That is, the high initial flow rate of gear pump 20 in the first step ensures uniformity at the leading edge, while reversal of gear pump 20 in the third step creates a clean break in the coating application at the trailing edge to prevent irregularities in the coating on the trailing edge of the patch that may be caused by the bead of the coating. It should be understood that the various embodiments of the coating system 20 and the coating distribution device 22 can be directed to a method of operating said system and device. In one embodiment of the method, container 24 is filled with coating 23. Coating 23 is then pumped through coating distribution device 22 and back to container 24 at a first flow rate. Coating distribution device 22 is then activated, which pumps a portion of coating 23 through the coating applicator die 31 and onto substrate 25 and a second flow rate less than the first flow rate.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

1. A coating system comprising:
a reservoir containing a coating;
a first pump in fluid communication with the reservoir and configured to pump coating from the reservoir through one or more distribution lines; and
a coating distribution device in fluid communication with and disposed downstream of the flow pump to receive coating, the coating distribution device including a motor, a second pump coupled to and driven by the motor to selectively apply the coating to a substrate in the form of a patch, the second pump configured to control flow of the coating through the coating distribution device at first flow rates to deposit the coating onto the substrate via an outlet, the second pump further configured to stop the flow of the coating through the coating distribution device to stop deposition of the coating on the substrate.

2. The coating system of claim 1, wherein the motor includes one of a servo motor or a stepper motor, and wherein the pump includes a reversible positive displacement gear pump.

3. The coating system of claim 1, wherein the first flow rates are positive flow rates and the second pump is configured to control flow of the coating in a first direction at the positive flow rates through the coating distribution device to deposit the coating onto the substrate, and wherein the second pump is configured to control flow of the coating in a second direction opposite the first direction at one or more negative flow rates to stop deposition of the coating on the substrate.

4. The coating system of claim 3, wherein the first pump controls the flow of the coating through the one or more distribution lines at a second flow rate that is faster than the first flow rates such that a portion of the coating flowing to the coating distribution device returns to the reservoir.

5. The coating system of claim 3, wherein the second pump is configured to control the flow of the coating in the second direction to at least partially withdraw the coating from the outlet.

6. The coating system of claim 1, wherein the coating is at least one of a slurry solution for a lithium-ion battery cathode, a slurry solution for a lithium-ion battery anode, or a liquid pharmaceutical.

7. The coating system of claim 1, wherein the coating distribution device further includes an applicator die coupled to the pump and defining the outlet.

8. The coating system of claim 1, further comprising a controller in communication with the motor, wherein the controller is programmed to generate a signal and the pump is configured to reverse flow of the coating to stop deposition of coating onto the substrate in response to the signal.

9. A web coating system comprising:
a transport roll supporting a substrate movable in a first direction at a first speed;
a reservoir containing a coating;
a first pump in fluid communication with the reservoir to pump fluid from the reservoir; and
a coating distribution device disposed downstream of the first pump and including an inlet in fluid communication with the first pump, the coating distribution device including a motor and a second pump configured to deposit at least a portion of the coating from the first pump onto the substrate via an outlet; and
a controller in operative communication with the transport roll and the motor, the controller programmed to determine a speed of the transport roll and to generate a control signal to control the predetermined flow rate(s) of the second pump, the second control signal based on a predetermined size and thickness of an area of coating to be applied to the substrate,
wherein the second pump is controlled by the controller at different flow rates to generate the predetermined size and thickness of the coating area on the substrate.

10. The system of claim 9, wherein the second pump is controlled by the controller for a first period of time at a first positive flow rate to initiate deposition of the coating onto the substrate, and wherein the second pump is controlled by the controller for a second period of time at a second positive flow rate that is slower than the first positive flow rate.

11. The system of claim 10, wherein the second period of time is longer than the first period of time.

12. The system of claim 10, wherein the second pump is controlled by the controller for a third period of time at a negative flow rate to stop deposition of the coating onto the substrate.

13. The system of claim 12, wherein control of the second pump at the negative flow rate withdraws coating from the outlet toward the inlet.

14. The system of claim 9, wherein the motor includes one of a servo motor or a stepper motor.

15. The system of claim 9, wherein the pump includes a reversible positive displacement gear pump.

16. A method of applying a coating to a substrate, the method comprising:
pumping the coating from a reservoir to a coating distribution device using a first pump;
applying the coating to the substrate using the coating distribution device, the coating distribution device including a motor and a second pump driven by the motor;
controlling the flow of the coating generated by the second pump through the coating distribution device via a controller at first flow rates to deposit the coating onto the substrate via an outlet; and
controlling the flow of the coating generated by the second pump through the coating distribution device via the controller at a second flow rate to stop deposition of the coating on the substrate.

17. The method of claim 16, wherein the first flow rates are positive flow rates and the second flow rate is a negative flow rate.

18. The method of claim 16, further comprising
pumping the coating in a first direction through the coating distribution device using the second pump at the first flow rates to deposit the coating onto the substrate; and
pumping the coating in a second direction opposite the first direction to stop deposition of the coating on the substrate.

19. The method of claim 18, further comprising withdrawing coating from the outlet back into the coating distribution device.

20. The method of claim 16, wherein applying the coating to the substrate includes operating the first pump at a first flow rate, operating the second pump at a second flow rate that is slower than the first flow rate, and returning a portion of the coating pumped by the first pump back to the reservoir.
